(19) United States
(12) Patent Application Publication
(10) Pub. No.: US 2007/0073611 A1
(43) Pub. Date: Mar. 29, 2007

(54) Third-party market center information delivery system

(75) Inventors: Jennifer L. Drake, Evanston, IL (US); David F. Weiss, Chicago, IL (US)

Correspondence Address: LEFEVOUR LAW GROUP, LLC, 4365 LAWN AVE, SUITE 5, WESTERN SPRINGS, IL, 60558, US

(73) Assignee: Archipelago Holdings, Inc.

(21) Appl. No.: 11/527,797

(22) Filed: Sep. 27, 2006

Related U.S. Application Data
(60) Provisional application No. 60/721,165, filed on Sep. 28, 2005.

(51) Int. Cl. G06Q 40/00

(52) U.S. Cl. 705/37; 705/35

(57) ABSTRACT

A system and method are disclosed for third-party information distributors to deliver information to market participants through a market center. The third-party information distributor can set when the information should and should not be distributed.

### CROSS-REFERENCE TO RELATED APPLICATIONS

This application claims priority from and claims the benefit of U.S. Provisional Application Ser. No. 60/721,165, filed Sep. 28, 2005, entitled “Third Party Market Center Information Delivery System,” which is hereby incorporated by reference.

### BACKGROUND

Market centers, such as securities exchanges, interact with market participants in real-time (e.g., market participants make security sales or purchases and the market center instantaneously provides trade reports, position reports). Such real-time interaction is necessary, in this day and age, for markets to operate effectively. Several factors, from inter-exchange competition to increasingly stringent governmental regulations, make the speed and efficiency of executing a financial instrument transaction (e.g., the purchase or sale of a security) the focus of a market center. Anything that is not necessary to a security transaction and that could get in the way of, or could potentially slow down, transaction processing is something that a market center tends to avoid, if at all possible. Because of this, market centers typically have no interest in delivering third-party information, such as prospectuses, as part of a security transaction, since such a delivery could interfere with the timely execution of the security transaction.

While market centers have no incentive, or more accurately have a disincentive, to deliver third-party transaction-related material to market participants, the third-parties, such as underwriters, have very strong incentives for wanting market centers to deliver their information to market participants at the time of the transaction. Cost savings and timely regulatory compliance are two of their most important motives. As it stands now, third-parties, such as underwriters, must distribute third-party materials after the security transaction has taken place on the market center. For example, underwriters must collect post-trade lists of buyers, affirmatively search out each buyer, build contact lists, and physically send the information to each buyer. Regardless of whether the contact lists are manually or automatically updated, or whether the information is sent as a paper document through the mail, or as an electronic document via e-mail, the process of tracking individual buyers and sending information is cumbersome, costly, and prone to error. Furthermore, trading industry rules or regulations often require organizations such as underwriters to communicate specific information to buyers within a specified time period (e.g., in some circumstances, a prospectus document must be sent to a buyer prior to or simultaneously with a trade confirmation report). In these cases any delayed, missed, or misdirected communications may lead to fines or other liabilities for an underwriter.

Accordingly, there is a need for a system and method that allows third-parties to deliver pertinent, and sometimes regulatory required, information to a market participant through the market center that executes the security transaction in a manner that does not impact the execution of the security transaction.

### SUMMARY

According to one aspect of the present invention, a method for delivering a third-party data file from a market center includes providing a data file created by a third-party information distributor to a market center, wherein the third-party data file is approved for distribution and is stored on the market center systems. The method further includes providing the third-party information distributor control to set a delivery status for the stored third-party data file and, wherein when the delivery status of the third-party data file is set to deliver and a position report is requested by a requester, creating a link to the third-party data file within the position report and sending the created position report to the requestor.

### DESCRIPTION OF THE DRAWINGS

These and other features, aspects and advantages of the present invention will become better understood with regard to the following description, appended claims and accompanying drawings where:

FIG. 1 is a block diagram illustrating the trading environment in which an embodiment of the present invention operates;

FIG. 2 illustrates a third-party information delivery process of the present invention;

FIG. 3 is an exemplary illustration of the third-party providing an electronic data file to a market center and setting the data for delivery;

FIG. 4 is an exemplary illustration of a market participant executing a trade; and

FIG. 5 is an exemplary illustration of the market center generating a report with a link to a third-party data file along with a notice that the file is available.

### DETAILED DESCRIPTION

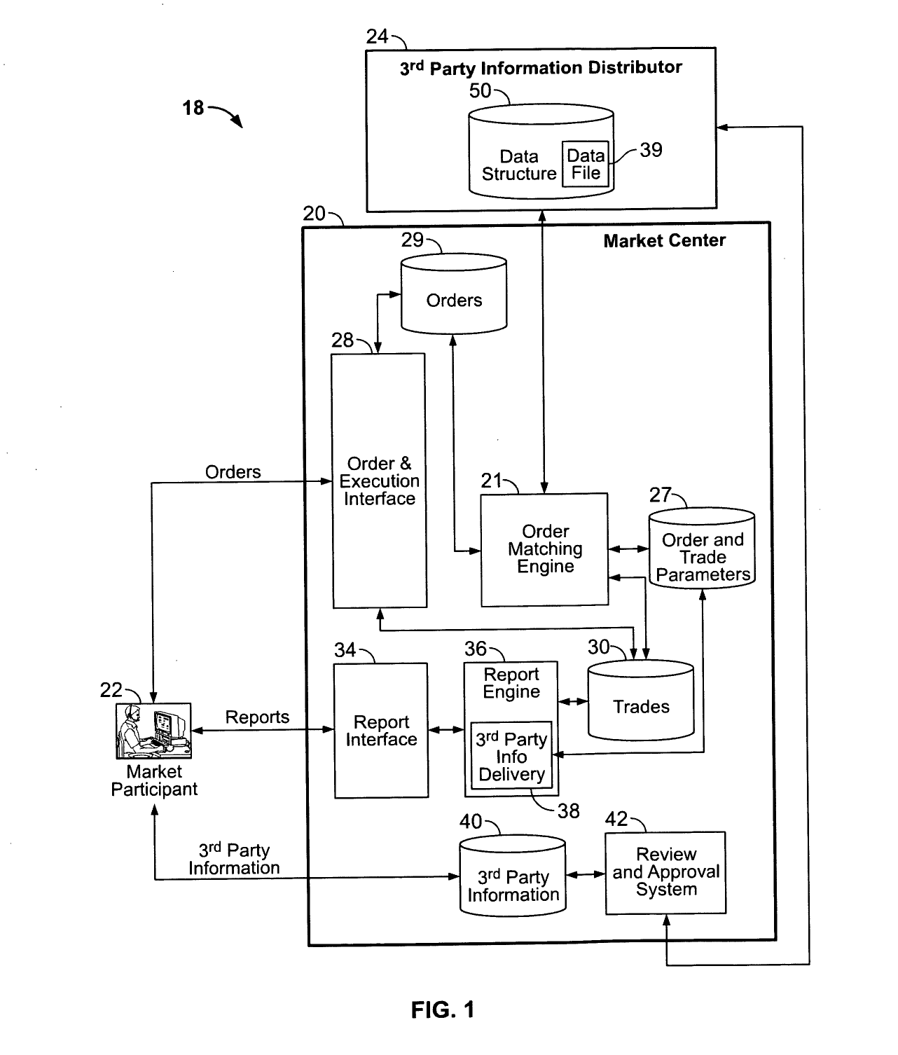

Referring to FIG. 1, a trading environment in which an embodiment of the third-party information delivery system 18 and method of the present invention operates is depicted. The examples discussed herein describe the use and application of the present invention in an equity security market center environment, but it should be understood that the present invention could be used in any type of financial instrument market center environment (e.g., equities, futures, options, bonds, etc.), or in any other environment that plays a central role in the trade reporting process, such as a clearing or settlement organization that serves all market participants 22 or any entity that has an integrated relationship with all market participants 22, that has access to all participants' transaction details, and that provides timely electronic reports to all participants. Furthermore, it should be noted that the examples herein depict market participant interactions with an electronic trading exchange interface, but the present invention is not dependent upon a specific type of trading interaction or methodology. Market centers 20 that offer open-outcry trading, for example, must ensure that all trading transactions are recorded in detail and reported to market participants 22. Therefore, whether the trading transaction is completed entirely within an electronic trading system, as depicted, or whether the trading details are entered after the actual trade has occurred directly between market participants 22 (e.g., information entered by market reporters on a trading floor), the present invention may be employed. Only one market participant 22 is depicted for simplicity, but it should be understood that in actuality, many market participants 22 could interact with the market center 20.

It should also be understood that the market center 20 referred to herein refers to a computing system having sufficient processing and memory capabilities and does not refer to a specific physical location. In fact, in certain embodiments, the computing system may be distributed over several physical locations. The electronic reporting features described can be applied to any electronic reporting formats or interfaces. For example, the present invention may be implemented in a client-server environment wherein the electronic information files are downloaded to a market participant's terminal or personal computer, a mainframe environment which only allows the remote display of the information files, or any other suitable system configuration.

The third-party information delivery system embodiment depicted includes a market center 20 and a third-party information distributor 24. The market center 20 includes an order matching engine 21, which validates, maintains, matches and processes all orders and quotes on the market center 20. The market center 20 may also include an order and trade parameters data structure 27. The order and trade parameters data structure 27 stores pre-defined trading parameters and rules that are used by the order matching engine 21 in reporting orders, reporting third-party information, matching orders and executing trades. The market center 20 may also include an order and execution interface 28 which interacts with the market participants 22 and the order matching engine 21 in the order execution process. The market center 20 may also include an order information data structure 29 where order information is stored, and a trade information data structure 30 where completed trade information is stored.

The market center 20 may also include a report engine 36 having a third-party information delivery routine 38, a report interface 34, a third-party information data structure 40 and a review and approval system 42.

As for the third-party information distributor 24 of the third-party information delivery system 18, it may include an information data structure 50 which stores files of data and documents 39 that the third-party information distributor 24 wants to distribute through the market center 20. Only one third-party information distributor 24 is depicted for simplicity, but it should be understood that in actuality, many third-party information distributors 24 could interact with the market center 20.

Throughout the discussion herein, it should be understood that the details regarding the operating environment, data structures, and other technological elements surrounding the reporting market center 20 and third-party information distributor 24 are by way of example and that the present invention may be implemented in various differing forms. For example, the data structures referred to herein may be implemented using any appropriate structure, data storage, or retrieval methodology (e.g., local or remote data storage in data bases, tables, internal arrays, etc.). Furthermore, a market center of the type described herein may support any type of suitable interface on any suitable computer system. It should be noted that the interaction between the third-party information distributor 24 and the market center 20 may be automated or manual. Specifically, the review and approval system 42, in a preferred embodiment, is a market center review committee that manually reviews documents submitted by third-party information distributors 24 and, after approval, loads the documents onto the third-party information data structure 40. In such an embodiment, documents may be submitted either electronically or manually to the market center review committee for review. It is also foreseen that in other embodiments, the entire review and approval process may be automated.

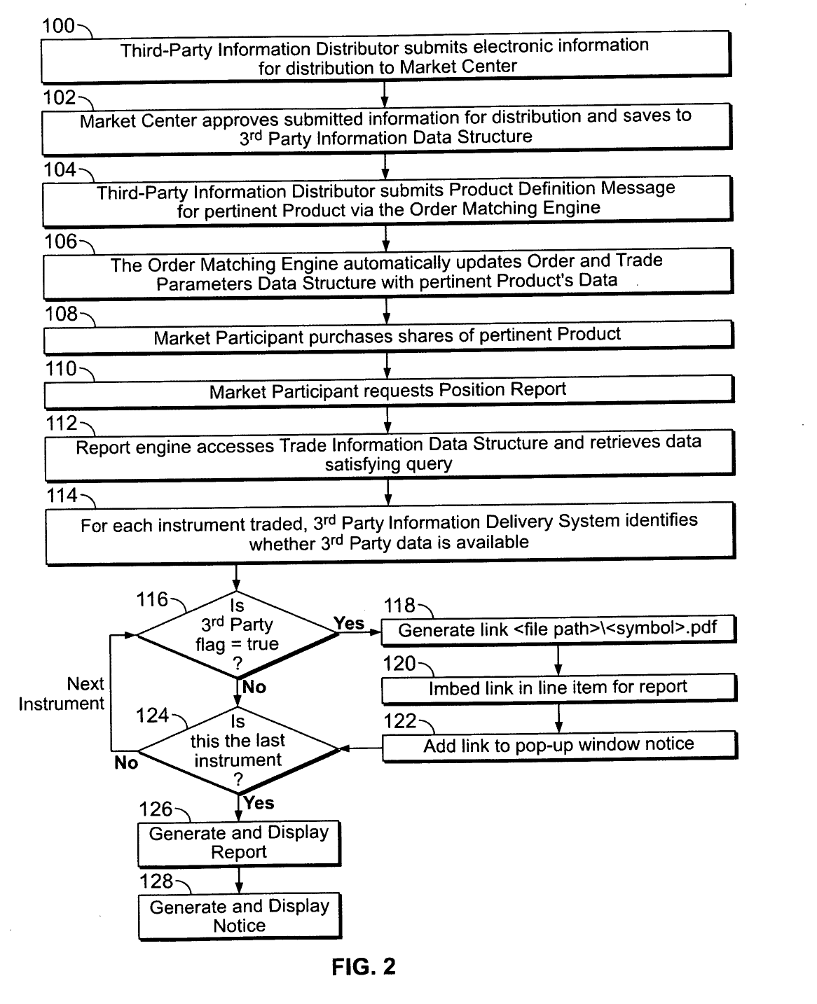

Referring to FIG. 2, the process, in a preferred embodiment, for a third-party to submit information for distribution to a market center and the process by which such information is distributed is illustrated. As indicated at step 100, a third-party desiring to distribute information submits a copy of the document to be distributed to the market center 20 for review and approval. As noted above, this step in the process may be manual or handled electronically. The third-party information distributor 24 submits a data file 39 of information for distribution to the review and approval system 42 of the market center 20 for review and approval. When the information submitted for review is approved, it is saved in the third-party information data structure 40, as indicated at step 102. The file must be saved in the proper format with the correct naming convention so that subsequent links that are automatically generated can be used to access the file.

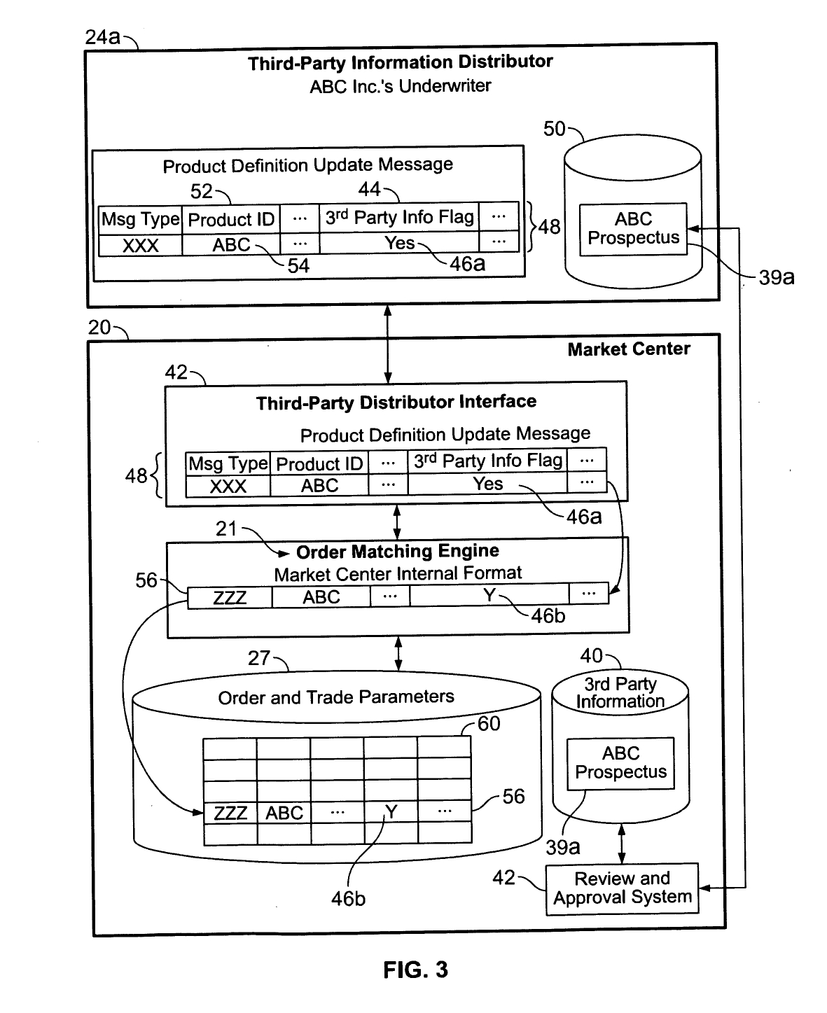

To activate the information for distribution, the third-party information distributor 24 generates a definition message 48 (FIG. 3) for the product that is to have information distributed via the market center 20. Within the product definition message 48 is a field indicating that third-party information is available for the given product. The third-party information distributor 24 then submits the definition message 48 to the market center 20, as indicated at step 104. Referring to FIG. 3, an exemplary definition message 48 is depicted. Within the definition message 48, the third-party information distributor 24 sets a flag 44 indicating whether or not a link to its information is to be included within market participant reports regarding the product specified in the definition message 48. The definition message 48 also includes a product identification field 52, which identifies the product that information is to be distributed for. In the example depicted in FIG. 3, “ABC” the product that information is to be distributed for, as indicated at 54, and the information availability flag field 44, in this example, is set to “true” “yes” 46a. In this embodiment, if a third-party information available flag 44 is set to a “true” condition, as indicated at 46a, information is available and should be distributed to market participants 22. If, on the other hand, field 46a is set to a “false” condition, information is not to be distributed.

At step 106, the order matching engine 21 receives the definition message 48, including the third-party information availability flag 44, from the third-party information distributor 24, and the order matching engine 21, in turn, updates the market center's internal record 56 for the product affected. If an incoming definition message 48 has the information distribution field 46a set to “true”, then the order matching engine 21 updates the corresponding field 46b of the market center's internal record 56 as part of its saving this updated record to the product records fields 60 on the order and trade parameters data structure 27.

At step 108, a market participant 22 purchases one or more shares of a pertinent financial instrument having information to distribute. Sometime after the purchase, the market participant 22, as indicated at step 110, requests an electronic position report using the market center's report interface 34. In response, the report engine 36, at step 112, accesses the trade information data structure 30 and retrieves the individual records that satisfy the query. At step 114, the process initiated by the activated third-party information delivery routine 38 identifies each product included in the returned report results. At step 116, for each product returned in the results to the query, the process checks the product record 56 in the order and trade parameters data structure 27. If the third-party information available flag for any product is set to a true condition, the process generates a link to the third-party information file 39 resident in the third-party information data structure 40, as indicated at step 118, and, in conjunction with the report engine 36, embeds the link in the report generated for that product. Simultaneously, the process generates a link for a pop-up window notice to be delivered to the market participant's display, as indicated at step 122. The process continues to check the product records 56 for each product traded until there are no further products to check, as indicated at step 124.

When all of the products are checked and all necessary links are generated for the report, the requested report is sent to the requesting market participant 22 and displayed, as indicated at steps 124 and 126. In any instances where at least one link to third-party information is generated, as with the examples illustrated herein, a notice containing the given link (or links) is generated in addition to the requested report, delivered to the market participant 22 and displayed, as indicated at step 128. However, it should be noted that if a market participant 22 has not traded any instruments which have third-party information available, the position report, in this embodiment, will not contain any dynamic third-party information links and the pop-up notice window will not be generated. It should also be understood that notification is not limited to pop-up windows and may be made in any suitable manner (e.g., a dynamic dialog box, a hypertext link in a file, etc.).

In this embodiment of the present invention, when third-party information is available, the market participant 22 may choose to interact with the dynamic link and view the information file, or the market participant may elect to ignore the link. Regardless of whether the market participant 22 (e.g., the buyer) views the information, the third-party information distributor 24, utilizing the process described above, has successfully made that information available to the pertinent market participant 22. In most instances where third-party information distributors 24 have an obligation to make information available to someone such as a buyer 22, the information distributors 24 do not have an obligation to force the individual 22 to actually access or read the information. In the event the recipient elects to view the file, the recipient activates the link by selecting it (e.g., by selecting a hypertext link or by whatever means of selection is incorporated into the report provided). The request retrieves the given file from the third-party information data structure 40.

In a preferred embodiment, the market center 20 maintains a copy of the given electronic information file in the third-party information data structure 40 as long as the related financial instrument definition record has a third-party information available flag that is set to “true.” When the third-party information distributor 24 no longer desires to make the information available to the recipient market participants 22, the third-party information distributor 24 sends the market center 20 an updated product definition message 48 with the third-party information available flag 46a set to a “false” condition. From that point forward, the report engine 36 and third-party information delivery routine 38 will no longer include any links for this financial instrument within the electronic reports or notices generated for market participants 22. In the system of the present invention, the market center 20 has the flexibility to use whatever administrative data structure maintenance techniques and procedures it determines are appropriate to remove an unaccessed information data file 39 from the data structure 40.

Referring to FIG. 3, as an example of the implementation of an embodiment of the present invention, a third-party information distributor 24a, an underwriter, is preparing to support the issuance of a new product, ABC. As part of that issuance, the underwriter wants all purchasers of ABC to receive a copy of the product's prospectus. In order to utilize the automated information distribution of the present invention offered by the market center 20, the underwriter creates an appropriate electronic copy of the prospectus document. The format of the electronic information file 39a is written in whatever format required by the given market center's report engine 36 (e.g., Adobe PDF, HTML, a proprietary report format, etc.). In this example, before the product is listed for trade on the market center 20, the underwriter submits an electronic copy of the ABC prospectus file 39a to the review and approval system 42 of the market center 20. After the electronic information file 39a is approved, it is saved in the market center's third-party information data structure 40 with a name that conforms to a designated naming convention (e.g., <symbol>.pdf, where “<symbol>” the unique symbol that identifies this instrument at the given market center 20, and the Adobe PDF format is the proper format for the given report system). The third-party information delivery routine 38 is capable of automatically generating the unique link that points to the given information file 39a based on that convention. For example, a market center 20 may save all such information files in a simple directory structure. If each file is named after the symbol of the instrument it relates to, and the file path is the same for all information files (because they are all saved in the same directory), then the third-party information distribution routine 38 can generate a link to the correct information file 39 based on the following file name convention: <file path>\<symbol name>.<xxx>, where <file path> is the path to the file's directory, <symbol> is the symbol that corresponds to an instrument and the associated file name in the directory, and <xxx> is the file extension for whatever file type is used in the implementation of this invention (e.g., pdf, htm, etc.). Once the electronic information file 39a is saved in the third-party information data structure 40, it can then be made available to market participants 22 who purchase the instrument.

Continuing with FIG. 3, the scenario where a third-party information distributor 24a updates the internal record for a product on the market center 20 is illustrated. The underwriter 24a for ABC updates the market center instrument definition record 56 to indicate that an information file 39a is available. In the example used herein, third-party information distributors 24 (e.g., underwriters) have dedicated electronic access that allows them to send product definition messages 48 electronically to the market center 20 via the matching engine 21. A field within the product definition update message 48 third-party information flag 44, which indicates whether or not third-party information is available for the given product. The internal instrument definition records 56 depicted herein are then stored in the order and trade parameters data structure 27. It should be understood that any methodology may be used to update a market center's instrument records and any properly configured data structure might be employed to store such definitions.

In this example, ABC's underwriter 24a has prepared a fixed-format product definition update message 48 containing the field designated as the third-party information flag 44. In this case, since the underwriter wishes any ABC purchasers to receive the ABC prospectus 39a, the flag 44 is set to “Y” 46a, which in this example indicates a true or yes condition, that third-party information is available. It should be kept in mind, however, than any type of indication methodology can be defined to show whether or not third-party information is available. Although a separate third-party information flag field 44 is illustrated in this product definition update message 48, the market center 20 and the third-party information distributors 24 could have instead agreed to re-define an existing field to serve as an indicator. For example, they might have agreed to use all upper-case letters in a specific text field if information is available and all lower-case letters in that field if information is not available. Any indication methodology can be employed, so long as all information distributors 24 and the market center 20 agree to a standard convention that can uniquely identify whether or not information is available regarding every instrument.

Continuing in this example, after the underwriter 24a generates the product definition update message 48, it transmits that message to the market center 20 using the standard data formats and communications protocols for their given environment. The message 48 is received at the market center 20 through the order matching engine 21. The order matching engine 21 then performs any tasks necessary to prepare the message 48 for processing. In this example, the market center 20 requires update messages 48 to be converted into a format that conforms to internal system standards since many systems use different internal standards than those used in external messages. Any internal format may be used so long as the third-party information flag 44 has some equivalent in the market center internal data format. When the order matching engine 21 completes this message normalization from the external update message format to the internal format, the record 56 is passed to the order and trade parameters data structure 27 which stores all product records 60.

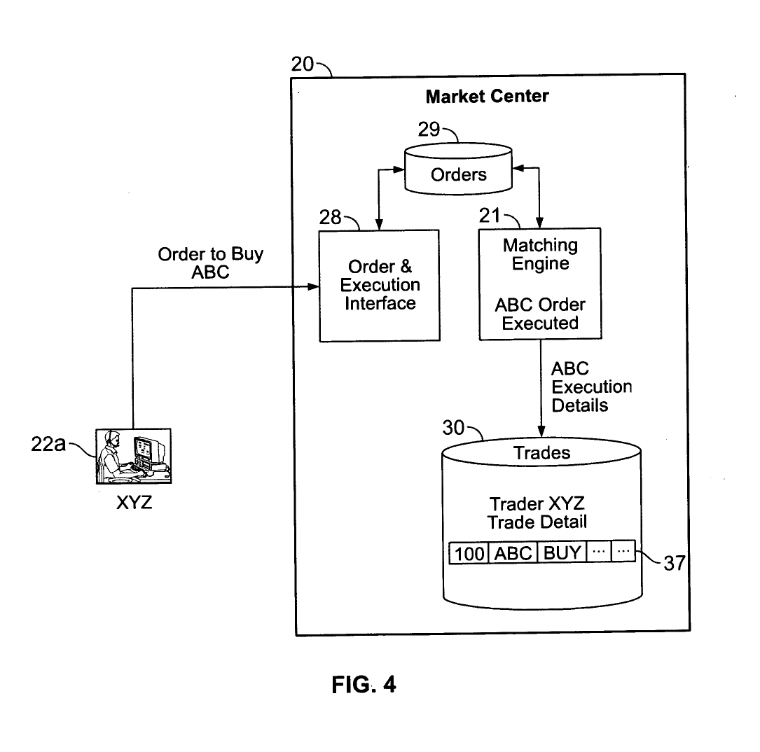

FIG. 4 shows market participant XYZ 22a interacting with the market center's trading interface 28 to place an order to buy product ABC. The matching engine 21 matches XYZ's buy order with equivalent sell orders and executes XYZ's trade. The matching engine 21 configures the transaction details and updates the trade information data structure 30 where the details for this trade are stored as a trade record 37. The format of this type of trade detail record 37 generally includes the financial instrument identification (i.e., the product symbol), and other details such as transaction time, price, volume, and so on.

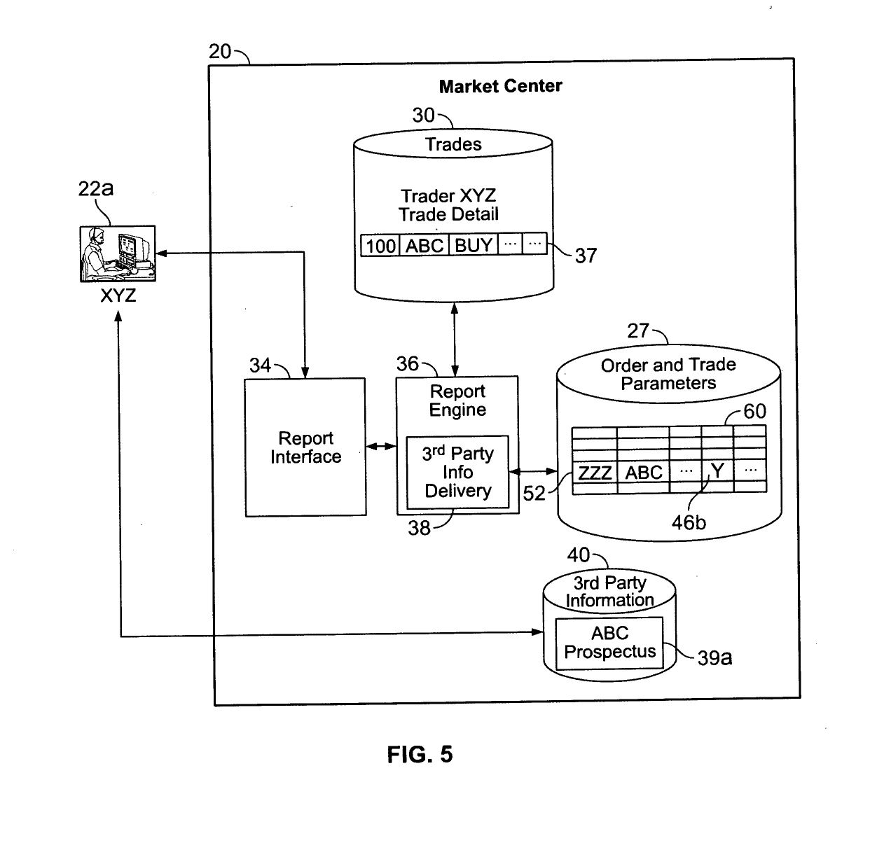

Referring now to FIG. 5, after trading has taken place and trading activity is confirmed, the market participant XYZ 22a requests an electronic report from the report interface 34 showing details of XYZ's trading positions (i.e., details regarding which financial instruments XYZ has bought or sold and what positions have resulted from the activity). In this example, market participant XYZ 22a is depicted as being able to initiate the report request, but the present invention may also be employed in environments where the market center 20 automatically generates and sends electronic position reports to market participants 22. With the market participant XYZ's request for a report, the report engine 36 is engaged and the third-party information delivery routine 38 is activated.

The activated process retrieves the product identifiers from XYZ's trade detail records 37 on the trade information data structure 30. In this case, the retrieved trade detail records 37 for the position report show that XYZ purchased shares of product ABC. The process then checks the product records 60 on the order and trade parameters data structure 27 to identify any products within XYZ's report results that contain a third-party information flag 46 set to “Y.” In this example, in record 56 for product ABC, the third-party information flag 46b is set to “Y.” As a result, as indicated at step 118, the process generates a link to the third-party information file 39a available for ABC. Then, as indicated at step 120, when the position report for XYZ is generated, the link is imbedded in the line item for the ABC product. When XYZ 22a opens the retrieved report and examines the file, XYZ can activate that link to retrieve the information file 39a from the third-party information data structure 40. However, to ensure that market participants 22 are additionally alerted to the existence of third-party information files 39, a notice message is also generated, as indicated at step 128, that includes any links to third-party information files 39. In this example, a pop-up window is opened automatically on XYZ's workstation. This pop-up window notice contains a dynamic link to the ABC third-party information file 39a which XYZ 22a, at his option, can select in order to view that file. In this embodiment, the notice window opens in addition to the window containing the position report actually requested by XYZ 22a. However, it should be understood that any method may be implemented to alert a market participant 22 to the existence of a third-party information file 39 relating to some financial instrument that provides a dynamic way for the market participant 22 to access that file 39 directly at his or her PC, client workstation, or terminal.

In this way, the ABC underwriter 24a has met its obligation to make the prospectus report available to all ABC buyers 22 in a timely way. The process for third-party information distributors 24, such as underwriters, to distribute information is simplified by allowing the information distributors 24 to provide the market center 20 with a single electronic copy of the information to be distributed 39. It also gives the third-party information distributor 24, the underwriter, the ability to control access to the information file 39 by simply setting the third-party information flag 44 to the appropriate setting and then submitting the updated product definition message 48 to the market center 20.

While this invention has been discussed in terms of certain embodiments, it should be understood that the invention is not so limited. The embodiments are explained herein by way of example, and there are numerous modifications, variations and other embodiments that may be employed that would still be within the scope of the present invention.

What is claimed is:

1. A method for distributing a third-party data file from a market center, comprising:
providing a third-party data file created by a third-party information distributor;
providing a market center, wherein the third-party data file is approved for distribution, associated with a financial instrument and stored on the market center;
providing the third-party information distributor control to set a distribution status field for the stored third-party data file;
wherein when the distribution status field for the third-party data file is set to distribute and a position report is requested by a requester for the financial instrument associated with the third-party data file, creating a position report with a link to the third-party data file generated therein; and
sending the created position report to the requestor.

2. The method of claim 1, wherein when the distribution status field for the third-party data file is set to not to distribute and a position report is requested by a requestor for the financial instrument associated with the third-party data file, creating a position report without a link to the third-party data file; and
sending the created position report to the requestor.

3. The method of claim 1, wherein when a position report with a link to the third-party data file generated therein is created, generating a notice regarding the third-party data file; and
sending the generated notice along with the created position report to the requestor.

4. The method of claim 3, wherein the generated notice is a pop-up window.

5. The method of claim 1, wherein the third-party data file is a prospectus document.

6. A method for distributing a third-party data file from a market center, comprising:
providing a third-party information distributor system having a third-party data file created by a third-party information distributor stored thereon;
providing a market center;
for the third-party information distributor, providing the third-party data file to the market center for approval and storage on the market center;
for the market center, reviewing the received third-party data file;
wherein if the received third-party data file is approved for distribution, associating the third-party data file with a financial instrument, creating a distribution status field for the associated financial instrument and storing the third-party data file on the market center;
for the third-party information distributor, setting the financial instrument distribution status field to distribute;
wherein when a position report is requested by a requestor for the financial instrument associated with the third-party data file, creating a position report with a link to the third-party data file generated therein; and
sending the created position report to the requester.

7. The method of claim 6, wherein the third-party information distributor sets the financial instrument distribution status field to not to distribute;
wherein when a position report is requested by a requestor for the financial instrument associated with the third-party data file, creating a position report without a link to the third-party data file; and
sending the created position report to the requestor.

8. The method of claim 6, wherein when a position report with a link to the third-party data file generated therein is created, generating a notice regarding the third-party data file; and
sending the generated notice along with the created position report to the requestor.

9. The method of claim 8, wherein the generated notice is a pop-up window.

10. The method of claim 6, wherein the third-party data file is a prospectus document.

11. A market center that distributes third-party data files, comprising:
a document storage data structure having a third-party data file associated with a financial instrument stored thereon and a parameter storage data structure having a distribution status field for the stored third-party data file, wherein the distribution status field is set to distribute for the stored third-party data file;
a market participant interface;
a market center memory for storing code for administering third-party data files and report generation;
a processor for interacting with the interface and executing the code for administering the third-party data files and report generation, wherein the code, when executed by a market participant requesting a position report:
determines that the financial instrument that a position report was requested on has a third-party data file associated with the financial instrument;
creates a position report with a link to the third-party data file generated therein; and
sends the created position report to the market participant.

12. The market center of claim 11, wherein when a position report with a link to the third-party data file generated therein is created, the executed code generates a notice regarding the third-party data file; and
sends the generated notice along with the created position report to the market participant.

13. The market center of claim 12, wherein the generated notice is a pop-up window.

14. The market center of claim 11, wherein the third-party data file is a prospectus document.

15. A third-party information distribution system, comprising:
a third-party information distributor system having a third-party data file created by a third-party information distributor stored thereon;
a market center having a document storage data structure, a parameter storage data structure and a market participant interface; a market center memory for storing code for administering third-party data files and report generation; and a market center processor for interacting with the interface and executing the code for administering the third-party data files and report generation, wherein:
the market center receives the third-party data file from the third-party information distributor system for review and approval;
upon approval, the market center associates the third-party data file with a financial instrument, creates a distribution status field for the associated financial instrument in the parameter storage data structure and stores the third-party data file on the document storage structure.

16. The third-party information distribution system of claim 15, wherein the third-party information distributor sets the financial instrument distribution status field to distribute;
wherein when a market participant requests a position report of the financial instrument associated with the third-party data file through the market participant interface, the market center creates a position report with a link to the third-party data file generated therein; and
sends the created position report to the market participant.

17. The third-party information distribution system of claim 16, wherein when a position report with a link to the third-party data file generated therein is created, the market center generates a notice regarding the third-party data file; and
sends the generated notice along with the created position report to the market participant.

18. The third-party information distribution system of claim 17, wherein the generated notice is a pop-up window.

19. The third-party information distribution system of claim 15, wherein the third-party data file is a prospectus document.

20. The third-party information distribution system of claim 15, wherein the third-party information distributor sets the financial instrument distribution status field to not to distribute;
wherein when a market participant requests a position report of the financial instrument associated with the third-party data file through the market participant interface, the market center creates a position report without a link to the third-party data file; and
sends the created position report to the market participant.
